(19) United States
(12) Patent Application Publication
(10) Pub. No.: US 2005/0222754 A1
(43) Pub. Date: Oct. 6, 2005

(54) SMS vehicle information system

(76) Inventors: Naftali Meisler, Petach Tikva (IL); Banny Israeli, Bney-Brak (IL)

Correspondence Address: Angenehm Law Firm Ltd., P.O. Box 48755, Coon Rapids, MN, 55448-0755, US

(21) Appl. No.: 11/094,463

(22) Filed: Mar. 30, 2005

Related U.S. Application Data
(60) Provisional application No. 60/557,380, filed on Mar. 30, 2004.

(51) Int. Cl. G01C 21/26

(52) U.S. Cl. 701/200; 455/414.2

(57) ABSTRACT

A transportation vehicle information (TVI) system comprising at least one CPU, operatively associated with at least one vehicle, having at least one database and including TVI on at least one vehicle and at least one position signal receiver adapted to receive at least one position signal, the at least one receiver being operatively associated with the at least one vehicle CPU. The system further including at least one vehicle Wireless Communication System (WCS) operatively associated with the at least one vehicle CPU and adapted to send at least one TVI signal and at least one SMS cellular provider, remote from the vehicle, the at least one provider adapted to receive the at least one TVI signal and transmit at least one SMS-based TVI message to at least one subscriber.

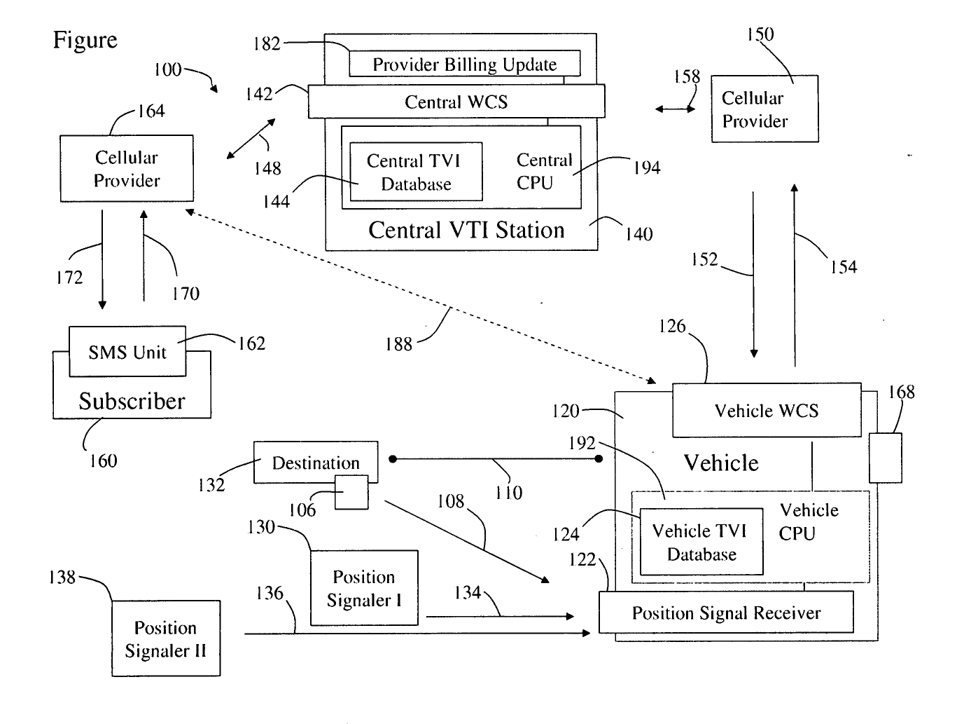

### RELATED APPLICATIONS

The present application claims priority from U.S. Provisional Application No. 60/557,380, herein incorporated in its entirety by reference.

### FIELD OF THE INVENTION

The present invention relates to devices and methods that provide transportation vehicle information using Short Messaging Service (SMS).

### BACKGROUND OF THE INVENTION

Transportation via trucks, buses, trains, motorcycles, airplanes, ships and cars, herein transportation vehicles, is an ubiquitous part of our fast-paced modern society. Knowing a transportation vehicle's location and projected arrival time at a given destination, herein transportation vehicle information (TVI), are important for efficient planning of transportation vehicle use.

Many tracking systems that track vehicle location use vehicle-mounted transmitters that provide position coordinates using a Wireless Communication System (WCS):

Flick. K. E. in U.S. patent application 20040201520, teaches a vehicle location system that uses cellular telephone technology; and Berard, et al in U.S. Pat. No. 5,515,043 teach a vehicle location system in which a user receives a vehicle's location and speed via telephone. Both patents, incorporated by reference herein in their entirety, provide TVI only to a limited group of users and only upon activation of the vehicle transmitter, for example following report of a theft.

### SUMMARY OF THE INVENTION

An aspect of an embodiment of the present invention relates to a TVI system comprising at least one CPU, operatively associated with at least one vehicle, having at least one database and including TVI on at least one vehicle.

The system further comprising at least one position signal receiver adapted to receive at least one position signal, the at least one receiver being operatively associated with the at least one vehicle CPU and at least one vehicle WCS operatively associated with the at least one vehicle CPU and adapted to send and receive at least one TVI signal. In an exemplary embodiment, the system includes at least one SMS cellular provider, remote from the vehicle, the at least one provider adapted to receive the at least one TVI signal and transmit at least one SMS-based TVI message to at least one subscriber.

In an exemplary embodiment, at least one position signal is generated from at least one position signaler and/or at least one cellular telephone triangulation service.

The present invention further relates to a method for generating SMS-based TVI, the method comprising generating a vehicle-based wireless TVI signal to an SMS provider, transforming the TVI signal into an SMS-based signal and transmitting an SMS-based signal to an SMS unit.

### BRIEF DESCRIPTION OF THE DRAWINGS

Exemplary non-limiting embodiments of the invention are described in the following description read with reference to the FIGURE attached hereto. Dimensions of components and features shown in the FIGURE are chosen primarily for convenience and clarity of presentation and are not necessarily to scale.

The attached FIGURE shows a block diagram of a TVI System, in accordance with an embodiment of the present invention.

### DESCRIPTION OF EXEMPLARY EMBODIMENTS

System Overview

The enclosed FIGURE shows an exemplary embodiment of a TVI system 100.

In broad terms, system 100 includes a central information station 140 that receives a TVI signal 154 transmitted from a transportation vehicle 120 to an SMS unit 162.

In one embodiment, TVI signal 154 includes location information transmitted by a signal 108 to vehicle WCS 126 from a signal generator 106 located at a destination 132. Signal 154 is transmitted by vehicle 120 to a central WCS 142 and transferred to a central processing unit (CPU) 194; CPU, herein, referring to any electronic circuitry that is associated with processing, storing and/or recalling information. In an exemplary embodiment, CPU 194 processes the TVI and stores the TVI in a vehicle-based database 144.

In an exemplary embodiment, a subscriber 160 generates a TVI request signal 170 from an SMS transmission unit 162, for example a mobile cellular telephone. TVI request signal 170 is received by a cellular provider 164, relayed to central WCS 142 and processed by central CPU 194.

Central CPU 194, in turn, sends a relay signal 148 that includes TVI from database 144 to cellular provider 164. Provider 164, in turn, sends an SMS-based TVI signal 172 to mobile SMS receiving unit 162, thereby providing subscriber 160 with TVI on vehicle 120.

In some exemplary embodiments, it may be desirable to limit access to TVI in system 100 to specific subscribers 160. To ensure that subscriber 160 is authorized to receive TVI on vehicle 120, the cell number of SMS unit 162 is pre-registered with database 144 so that only authorized unit 162 may receive TVI. Additionally or alternatively, subscriber 160 enters a personal identification number (PIN) registered with database 144 to receive clearance for obtaining TVI.

Optionally, system 100 includes a cellular provider billing module 182 that generates daily, weekly or monthly statements informing cellular provider 164 of activity related to subscriber 160. In an exemplary embodiment, provider 164 collects payment from subscriber 160 for activity and transfers payments to system 100. These, and other billing methods, may be implemented using a variety of systems and/or methods known to those familiar with the art.

The components associated with vehicle 120 and central TVI station 140 will now be described in detail to convey the scope of the present invention. A person familiar with the state of the art will recognize that the present invention may be embodied in many different forms and should not be construed as limited to the illustrated embodiments set forth herein.

Vehicle Components

While position signaler 130 has been described as a signaler 106 associated with destination 132 that transmits signal beacon 108, many alternatives to signal generator 106 may be utilized that are known to those familiar with the art.

For example, position signalers 130 and 138, comprising ground-based cellular antennae stations that presently exist throughout the world, may be used to provide cellular telephone-based triangulation services to vehicle 120. Vehicle TVI database 124, for example, includes a position conversation database that analyzes triangulation information and calculates a position with respect to destination 132.

Optionally, it subscriber 160 wishes to determine the distance directly to vehicle 120, position signalers 130 and 138 may be used to triangulate the location of both subscribe 160 and vehicle 120, through wich the distance is derived.

As is known to those familiar with the art, the precision of TVI may be, for example, dependent upon the density of signalers 130 and 138. For example, a larger number of signalers 130 and 138 are usually located within an urban area, facilitating triangulation of position of vehicle 120, for example within 100 meters. Between urban areas, a smaller number of signalers 130 and 138 are usually located, facilitating triangulation of position of vehicle 120 within 500 meters.

While relays 148 and 158 are described as being wireless cellular communication, they may include other technology, for example cellular modem and/or a hard-wired Internet connection, using methods and devices that are well-known to those familiar with the art.

In an alternative exemplary embodiment, vehicle 120 includes a Global Positioning System (GPS) receiver 164 that receives signals from GPS satellites. In an exemplary embodiment, vehicle 120 transmits GPS based position information 154 to cellular provider 150.

In an exemplary embodiment, Cellular Provider 150 sends and/or receives information via General Packet Radio Service (GPRS). The cost of GPRS service is typically based upon the volume of monthly requests from vehicle 120.

In an alternative embodiment of system 100, all information contained in central TVI station 140 is contained in vehicle CPU 192 and vehicle WCS 126 communicates with cellular provider 164. In this manner, vehicle 120 provides direct signals 188 to provider 164 that are turned into SMS signals 172 and received by SMS unit 162.

As is known to those familiar with the art, vehicle WCS 126, CPI 192 and Signal Receiver 122 are easily offered in small or miniature sizes that allow mounting for example on a motorcycle, enabling system 100 to be used to provide TVI on motorcycles that deliver hot foods, for example pizza.

In an exemplary embodiment, CPU 192 is equipped to monitor and/or actuate a variety of devices related to local conditions in vehicle 120, for example fuel level. In an exemplary embodiment, CPU 192 and/or central CPU 194 receive fuel level information from vehicle 194, estimate the necessity and/or time required for a fuel stop and accordingly revise the expected arrival time of vehicle 120 at destination 132.

Additionally or alternatively, vehicle WCS 126 may receive local information, for example the average vehicle travel speed on urban roads along route 110. In an exemplary embodiment, the local information is transmitted to, and processed by, vehicle CPU 192, thereby adding further precision to destination arrival time.

In a related embodiment, embodiments of system 100 may be used to enhance TVI services associated with a wide variety of vehicles 120, for example a non-commercial household vehicle 120.

In an exemplary embodiment, subscriber 160 comprises a parent concerned about the safety of a teenager driving vehicle 120 and requests TVI information from vehicle WCS 126. Additionally or alternatively, CPU 192 may include one or more door lock monitors and/or actuators so that a subscriber 160 can be assured that vehicle 120 is properly locked.

Epilogue

While the invention has been described with respect to a limited number of embodiments, it will be appreciated that many variations, modifications and other applications of the invention may be made. Also, combination of elements from variations may be combined and single elements may be used. Such variations and modifications, as well as others that may become apparent to those skilled in the art are intended to be included within the scope of the invention, as defined by the appended claims.

The terms “include”, “comprise” and “have” and their conjugates as used herein mean “including but not necessarily limited to.”

It will be appreciated by a person skilled in the art that the present invention is not limited by what has thus far been described. Rather, the scope of the present invention is limited only by the following claims.

1. A transportation vehicle information (TVI) system comprising:
i) at least one CPU, operatively associated with at least one vehicle, having at least one database and including TVI on at least one vehicle;
ii) at least one position signal receiver adapted to receive at least one position signal, the at least one receiver being operatively associated with the at least one vehicle CPU;
iii) at least one vehicle Wireless Communication System (WCS) operatively associated with the at least one vehicle CPU and adapted to transmit at least one TVI signal; and
iv) at least one SMS cellular provider, remote from the vehicle, the at least one provider adapted to receive the at least one TVI signal and transmit at least one SMS-based TVI message to at least one subscriber.

2. The vehicle transit system according to claim 1, wherein the at least one position signal is generated from at least one of:
at least one position signaler; and
at least one cellular telephone triangulation service.

3. The vehicle transit system according to claim 1, wherein the at least one position signaler provides GPS and the vehicle is equipped with at least one GPS receiver.

4. The vehicle transit system according to claim 1, wherein the at least one SMS provider communicates with the at least one vehicle WCS using at least one of:
an Internet connection;
GPRS;
Wireless Modem; and
SMS.

5. The vehicle transit system according to claim 1, further including at least one billing-processing unit connected to the at least one CPU, adapted to process at least one billing.

6. The vehicle transit system according to claim 1, wherein the at least one vehicle CPU performs at least one of the following:
monitor; and
actuate,
in conjunction with at least one of:
at least one fuel level gage; and
at least one door lock.

7. The vehicle transit system according to claim 1, wherein the at least one database includes registration information on at least two subscribers and limits TVI information access to at least one subscriber.

8. A method for generating SMS-based TVI, the method comprising:
generating a vehicle-based wireless TVI signal to an SMS provider;
transforming the TVI signal into an SMS-based signal; and
transmitting an SMS-based signal to an SMS unit.

9. The method of claim 8 further including, requesting SMSM-based TVI information.

10. A TVI system comprising:
a) a central station, including:
i) at least one CPU having at least one database including TVI on at least one vehicle;
ii) at least one WCS operatively associated with the at least one CPU and adapted to transmit at least one TVI signal;
b) a vehicle station, including:
i) at least one CPU, operatively associated with at least one vehicle, having at least one database and including TVI on at least one vehicle;
ii) at least one position signal receiver adapted to receive at least one position signal, the at least one receiver being operatively associated with the at least one vehicle CPU;
iii) at least one vehicle WCS operatively associated with the at least one vehicle CPU and adapted to transmit at least one TVI signal; and
c) at least one SMS cellular provider, remote from the vehicle, the at least one provider adapted to receive at least one TVI signal and transmit at least one SMS-based TVI message to at least one subscriber.

11. The vehicle transit system according to claim 10, wherein at least one position signal is generated from at least one of:
at least one position signaler; and
at least one cellular telephone triangulation service.

12. The vehicle transit system according to claim 10, wherein the at least one position signaler provides GPS and the vehicle is equipped with at least one GPS receiver.

13. The vehicle transit system according to claim 10, wherein the at least one SMS provider communicates with at least one WCS using at least one of:
an Internet connection;
GPRS;
Wireless Modem; and
SMS.

14. The vehicle transit system according to claim 10, further including at least one billing-processing unit connected to the at least one of:
the central CPU; and
the vehicle CPU;
and the at least one processing unit is adapted to process at least one billing.

15. The vehicle transit system according to claim 10, wherein the at least one vehicle CPU performs at least one of the following:
monitor; and
actuate
in conjunction with at least one of:
at least one fuel level gage; and
at least one door lock.

16. The vehicle transit system according to claim 10, wherein at least one of:
the central database; and
the vehicle database,
includes registration information on at least two subscribers and limits TVI information access to at least one subscriber.
